(19) United States
(12) Patent Application Publication
(10) Pub. No.: US 2013/0036580 A1
(43) Pub. Date: Feb. 14, 2013

(54) Strap-Tensioning Apparatus

(71) Applicant: Han-Ching Huang, Taichung City (TW)

(72) Inventor: Han-Ching Huang, Taichung City (TW)

(21) Appl. No.: 13/206,107

(22) Filed: Aug. 9, 2011

(51) Int. Cl. B60P 7/06

(52) U.S. Cl. 24/68 CD

(57) ABSTRACT

A strap-tensioning apparatus includes a frame, a handle, a reel, a coil spring, a brake and two detents. The frame includes two walls each including two edges. A strap is wound on the reel. The handle includes two cams for pushing the first detent from ratcheted wheels of the reel when the second detent is located on the second edges. When the second detent is located on the second edges, the second detent is movable between a first position in contact with the ratcheted wheels and a second position away from the ratcheted wheels. In the second position, the second detent keeps the brake from the ratcheted wheels. The distance of the ratchets from the axle is longer than the distance of the second edges from the axle. Thus, the second detent frictionally contacts the ratcheted wheels in the second position, thus slowing the reeling in of the strap.

### BACKGROUND OF INVENTION

1. Field of Invention

The present invention relates to a strap-tensioning apparatus and, more particularly, to a safe, convenient strap-tensioning apparatus.

2. Related Prior Art

Strap-tensioning apparatuses are used for fastening goods on vehicles such as trucks, trailers, electric cars, aircrafts and boats. The operation of the strap-tensioning apparatuses is easy and thus saves time and labor. Some of the strap-tensioning apparatus automatically reel in straps after use, and this is convenient.

Referring to FIGS. 1 and 2, there is shown a conventional strap-tensioning apparatus 100. Details of the conventional strap-tensioning apparatus 100 can be found in Chinese Patent Application Publication No. 2936490. The conventional strap-tensioning apparatus 100 includes a frame 10 pivotally connected to a handle 20 by an axle 70. A reel 90 is supported on the axle 70 so that they can only be rotated together. The reel 90 is formed with two ratcheted wheels 91 each on a side for confining a long strap 14 on the reel 90. Each of the ratcheted wheels 91 of course includes a plurality of ratchets 92 formed on and along an edge. An automatic reeling-in unit 50 is also supported on the axle 70. The automatic reeling-in unit 50 includes a coil spring 52 located in a shell 51. The coil spring 52 includes an end located in and secured to the shell 51 and another end secured to the axle 70. Thus, the automatic reeling-in unit 50 tends to rotate the reel 90 to reel in the long strap 14.

The frame 10 includes a front end and a rear end. A detent assembly 40 is located between two walls of the frame 10 near the front end. A bolt 80 is located between the walls of the frame 10 near the rear end. Each of the walls of the frame 10 is formed with a first arched edge 12, a second arched edge 13, and a boss 11 between the first arched edge 12 and the second arched edge 13.

The detent assembly 40 includes a detent 41 biased by a compression spring 42 located against a crossbar supported on the walls of the frame 10. The compression spring 42 biases the detent 41 toward the axle 70 for engagement with one of the ratchets 92 of each of the ratcheted wheels 91.

The bolt 80 is inserted through a loop formed at an end of a short strap 16 and a brake assembly 60. Like the long strap 14, the short strap 16 is tied to a hook 15 at another end. The brake assembly 60 includes a brake 61 supported on the bolt 80 and a torque spring 62 for biasing the brake 61. Located against the frame 10, the torque spring 62 causes the brake 61 to pivot around the bolt 80 and abut against one of the ratchets 92 of each of the ratcheted wheels 91.

The handle 20 includes two cams 21 extending from a lower face thereof and an opening 22 defined therein. The handle 20 can be pivoted to pivot the cams 21 to push the detent 41 and/or the brake 61 away from the ratcheted wheels 91.

Below the opening 22 of the handle 20, there is provided a detent assembly 30. The detent assembly 30 includes a detent 31 biased by a torque spring 32. The detent 31 includes a tab 33 and two pushers 34. The tab 33 and the pushers 34 extend from an edge of the detent 31. The tab 33 is accessible through the opening 22 of the handle 20. The pushers 34 are directed toward the brake 61.

Referring to FIG. 3, the handle 20 is located on the second arched edges 13 of the walls of the frame 10 so that the cams 21 push the detent 41 away from the ratchets 92. The distance of the second arched edge 13 from the axle 70 is longer than the distance of the axle 70 from the tips of the ratchets 92. Thus, the detent 31 is kept away from the ratcheted wheels 91 by the second arched edges 13 of the walls of the frame 10. However, the torque spring 62 still pushes the brake 61 against the ratcheted wheels 91. A torque resulting from the friction between the brake 61 and the ratcheted wheels 91 overcomes another torque resulting from the recovering force exerted on the ratcheted wheels 91 by the coil spring 52 through the axle 70. Therefore, the reel 90 cannot be rotated.

The brake 61 is not engaged with the ratchets 92. The brake 61 is only in contact with the ratchets 92 so that the brake 61 stops the ratcheted wheels 91 from rotation only by the friction. A force can be exerted on the long strap 14 and transferred to the ratcheted wheels 91 to overcome the friction to reel out the long strap 14. Once the force is stopped, the long strap 14 is stopped, not reeled in, because the brake 61 still exerts the friction against the ratchets 92. Thus, the long strap 14 cannot be reeled in at all and the hook 15 will not hurt anybody nearby.

To reel in the long strap 14, a user may choose from two processes. The first process will be described referring to FIG. 4 while the second process will be described referring to FIG. 5.

Referring to FIG. 4, the distance of the first arched edge 12 from the axle 70 is shorter than the distance of the axle 70 from the ratchets 92 so that the detent 31 abuts against one of the ratchets 92 of each of the ratcheted wheels 91. Now, the cams 21 are located between the detent 41 and the brake 61 so that the detent 41 is engaged with one of the ratchets 92 of each of the ratcheted wheels 91 to stop the ratcheted wheels 91 from rotation corresponding to the reeling out of the long strap 14. Thus, the long strap 14 is locked. By pivoting the handle 20 toward the detent assembly 40 from the boss 11, the detent 31 is engaged with the ratchets 92 to rotate the ratcheted wheel 91 so that the reel 90 reels in the long strap 14. Now, the ratchets 92 push away the detent 41 and the brake 61 so that the rotating of the ratcheted wheels 91 continues.

The handle 20 is moved to an end of the first arched edge 12 of each of the walls of the frame 10 before it is moved back toward the boss 11. The detent 41 is engaged with the ratchets 92 to stop the ratcheted wheel 91 from rotating corresponding to the reeling out of the long strap 14. Furthermore, biased by the torque spring 62, the brake 61 still abuts against the ratchets 92 to hold the reel 90 still. Together with the handle 20, the detent 31 is moved past at least one of the ratchets 92 of each of the ratcheted wheels 91 back to another end of the first arched edge 12 in the vicinity of the boss 11. The detent 31 is engaged with one of the ratchets 92 of each of the ratcheted wheels 91 again. The handle 20 can be pivoted again to further reel in the long strap 14.

The first process for reeling in the long strap 14 is manual. The first process for reeling in the long strap 14 is slow.

Referring to FIG. 5, the handle 20 is located in the second arched edge 13, and the tab 33 of the detent 31 is pushed so that the pushers 34 rotate the brake 61 around the bolt 80 so that the friction between the brake 61 and the ratchets 92 of the ratcheted wheel 91 is reduced or the brake 61 is disengaged from the ratchets 92 of the ratcheted wheel 91. Now, the recovering force of the coil spring 52 is larger than the friction between the brake 61 and the ratchets 92 of the ratcheted wheel 91. Thus, the coil spring 52 rotates the reel 90 to reel in the long strap 14 automatically.

The automatic reeling in of the long strap 14 is however very fast and so is the movement of the hook 15. Thus, any person nearby might get hurt by the fast moving hook 15. Although a user can adjust the friction between the brake 61 and the ratchets 92 of the ratcheted wheel 91 by adjusting the force exerted on the tab 33, such adjustment is difficult and not precise. The risk of a fast moving hook 15 hurting someone is still high.

The present invention is therefore intended to obviate or at least alleviate the problems encountered in prior art.

### SUMMARY OF INVENTION

It is the objective of the present invention to provide a safe, convenient strap-tensioning apparatus.

To achieve the foregoing objective, the strap-tensioning apparatus includes a frame, a bolt, an axle, a reel, a coil spring, a spring-biased brake, a handle and two spring-biased detents. The frame includes two walls each including first and second arched edges formed thereon. The bolt is supported on the frame. A short strap is tied to the bolt. The axle is supported on the frame. The reel is supported on the axle and formed with two ratcheted wheels each formed with a plurality of ratchets. A long strap is wound on the reel. The coil spring tends to rotate the reel to reel in the long strap. The first spring-biased detent is supported on the frame for engagement with the ratchets. The spring-biased brake is supported on the frame for contact with the ratchets. The handle is supported on the axle and formed with two cams. The second spring-biased detent is pivotally attached to the handle. As the second spring-biased detent is located on the second arched edges of the walls of the frame, the cams push the first spring-biased detent away from the ratchets and the second spring-biased detent can be pivoted between a first position in contact with the ratchets and a second position away from the ratchets. The second spring-biased detent keeps the spring-biased brake away from the ratchets in the second position. The distance of the ratchets from the axle is longer than the distance of the second arched edges from the axle so that the second spring-biased detent frictionally contacts the ratchets on the second arched edges in the second position, thus slowing the reeling in of the long strap.

Other objectives, advantages and features of the present invention will be apparent from the following description referring to the attached drawings.

### BRIEF DESCRIPTION OF DRAWINGS

The present invention will be described via detailed illustration of the preferred embodiment versus the prior art referring to the drawings wherein:

FIG. 1 is a perspective view of a conventional strap-tensioning apparatus;

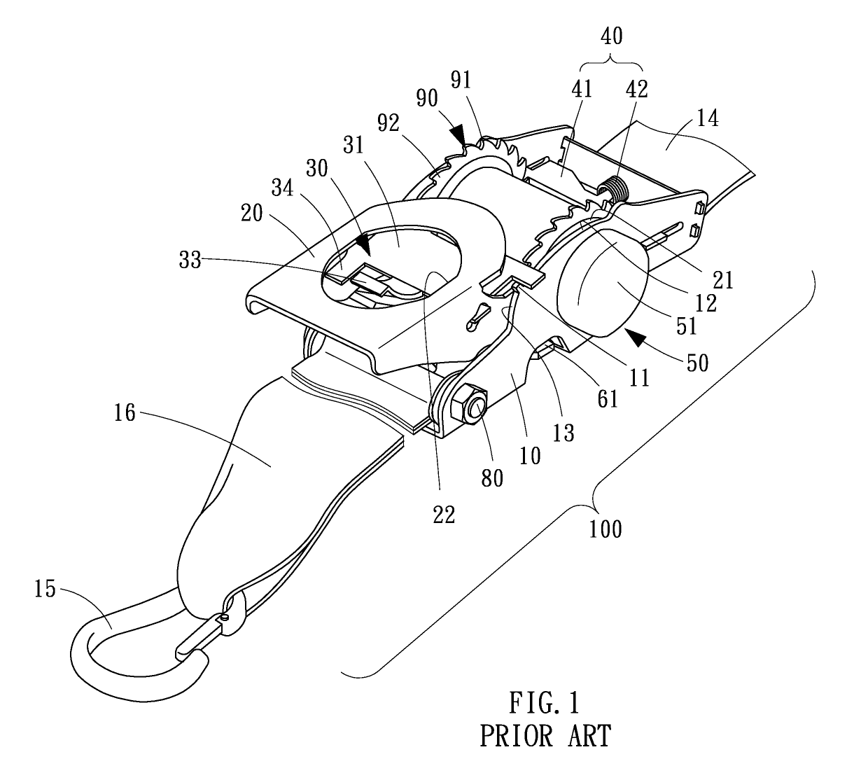

FIG. 2 is an exploded view of the conventional strap-tensioning apparatus shown in FIG. 1;

FIG. 3 is a cross-sectional view of the conventional strap-tensioning apparatus shown in FIG. 1;

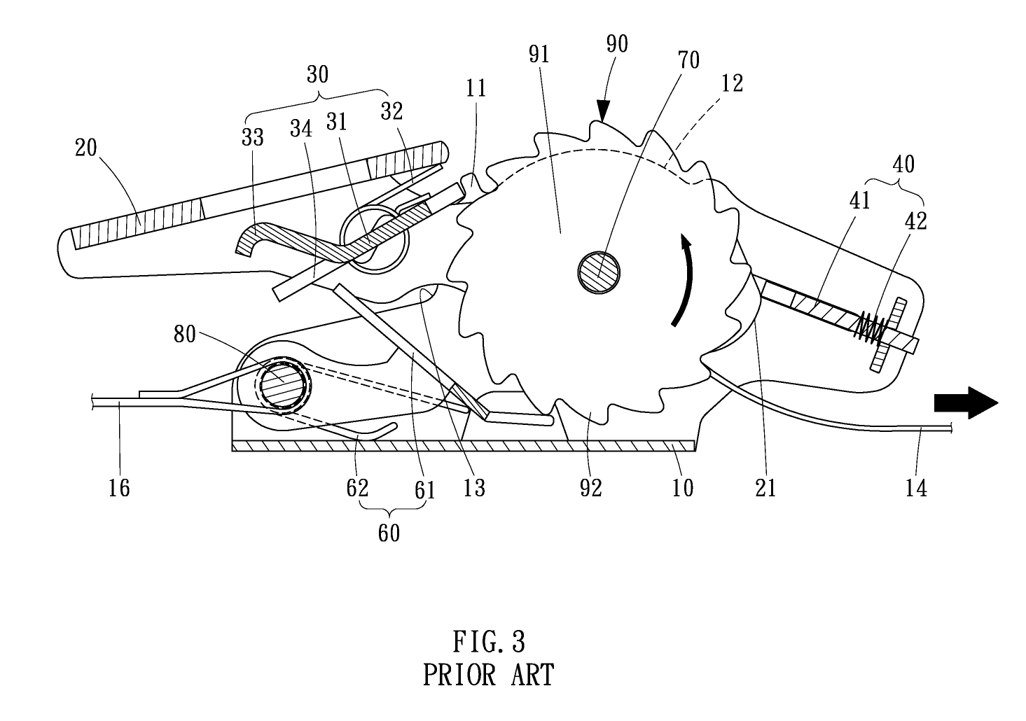

FIG. 4 is a cross-sectional view of the conventional strap-tensioning apparatus in another position than shown in FIG. 3;

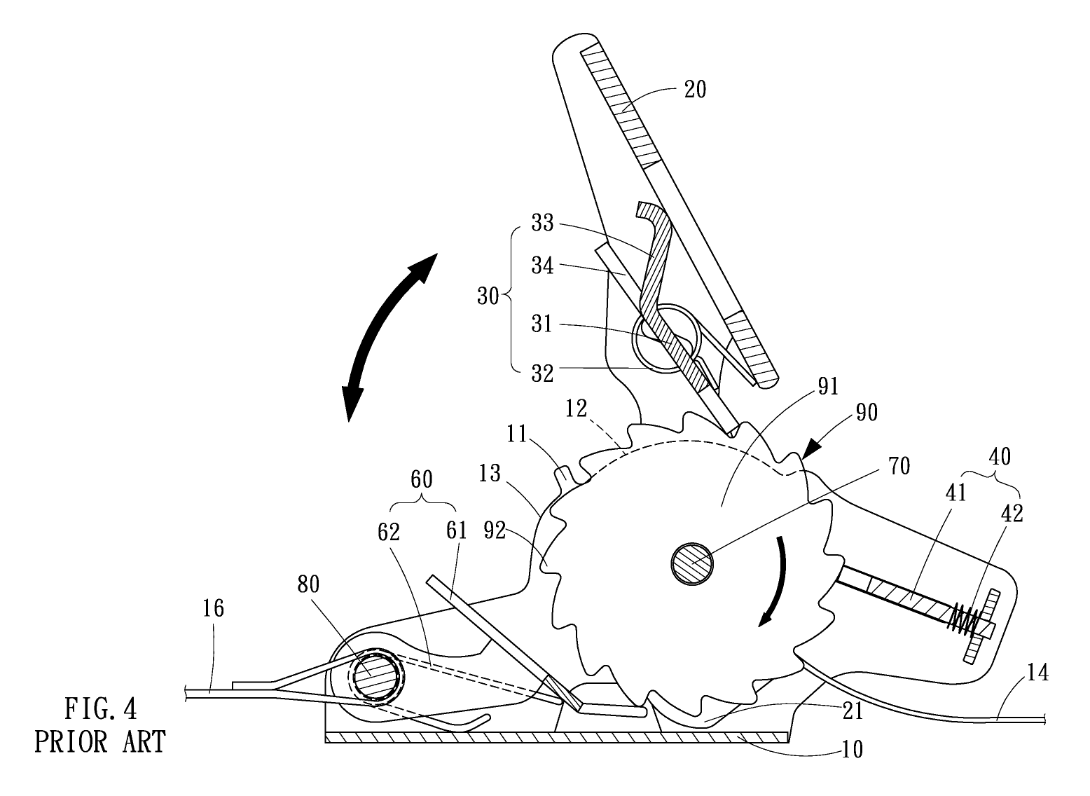

FIG. 5 is a cross-sectional view of the conventional strap-tensioning apparatus in another position than shown in FIG. 4;

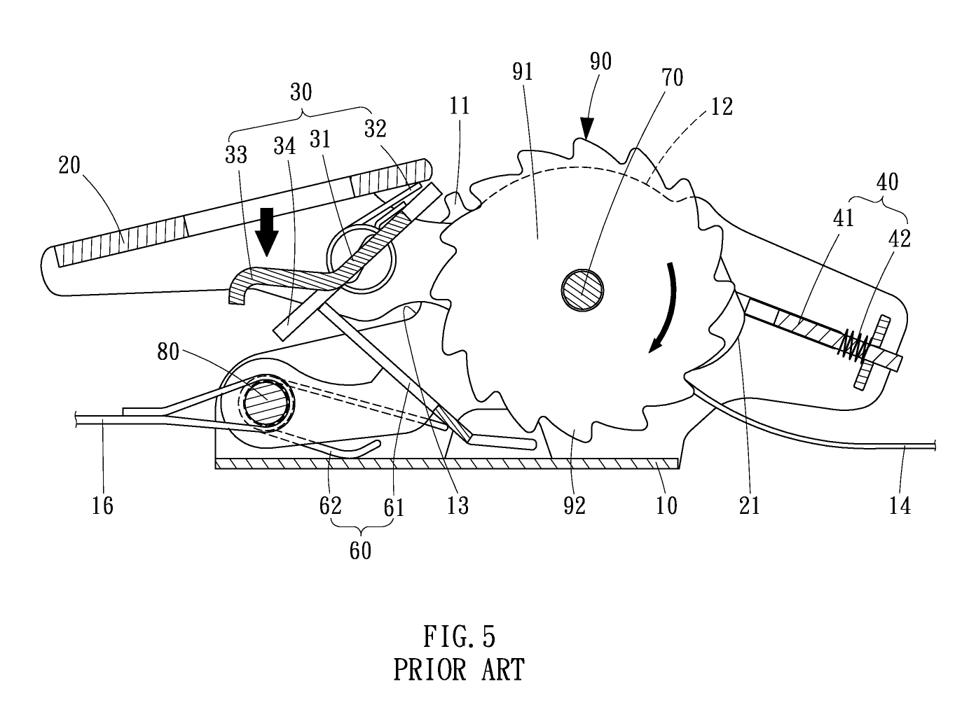

FIG. 6 is a cross-sectional view of a strap-tensioning apparatus in accordance with the preferred embodiment of the present invention;

FIG. 7 is a cross-sectional view of the strap-tensioning apparatus in another position than shown in FIG. 6; and

FIG. 8 is a cross-sectional view of the strap-tensioning apparatus in another position than shown in FIG. 7.

### DETAILED DESCRIPTION OF PREFERRED EMBODIMENT

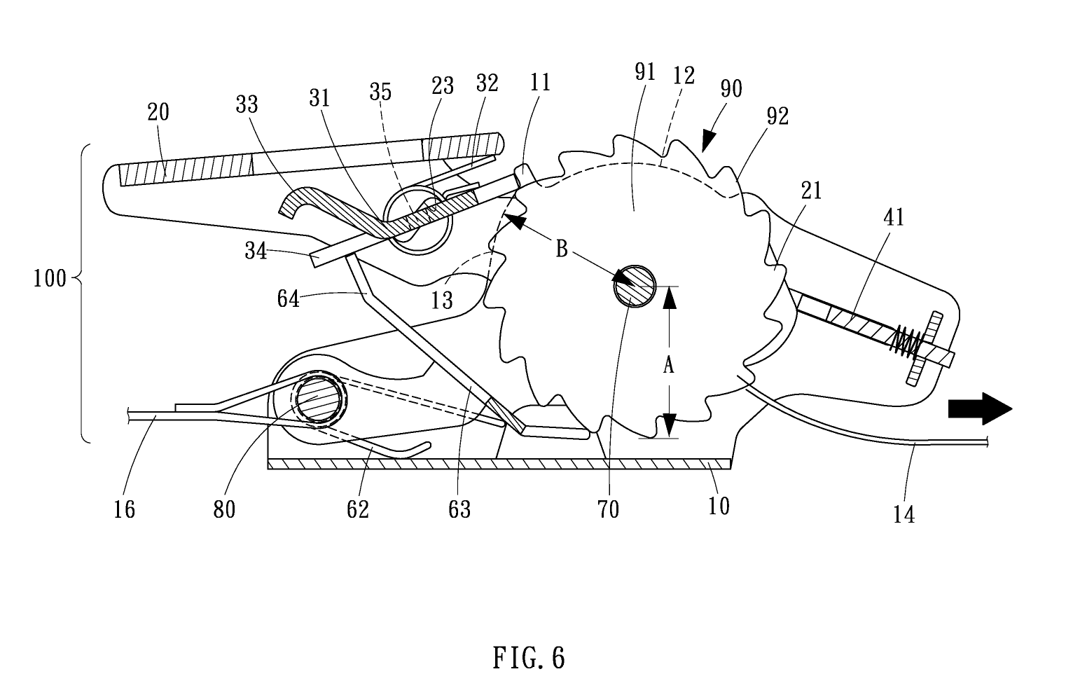

Referring to FIG. 6, there is shown a strap-tensioning apparatus 100 in accordance with the preferred embodiment of the present invention. The strap-tensioning apparatus 100 of the present invention is like the conventional strap-tensioning apparatus of the prior art. For briefness of the description, common features of the strap-tensioning apparatuses will be not described. The strap-tensioning apparatus 100 of the present invention is identical to the conventional strap-tensioning apparatus discussed in the prior art except several points.

At first, the distance A of the tips of the ratchets 92 from the axle 70 is longer than the distance B of the axle 70 from the second arched edges 13 of the walls of the frame 10. Thus, the detent 31 is in contact with the ratchets 92 as the detent 31 is located on the second arched edges 13 of the walls of the frame 10.

Secondly, a brake 63 is used instead of the brake 61. The brake 63 is like the brake 61 except including two levers 64 extending from an edge. The angle between the levers 64 and the brake 63 is about 120°. The levers 64 are abutted against the pushers 34 of the detent 31 to enable the handle 20 to pivot on the second arched edges 13 of the walls of the frame 10.

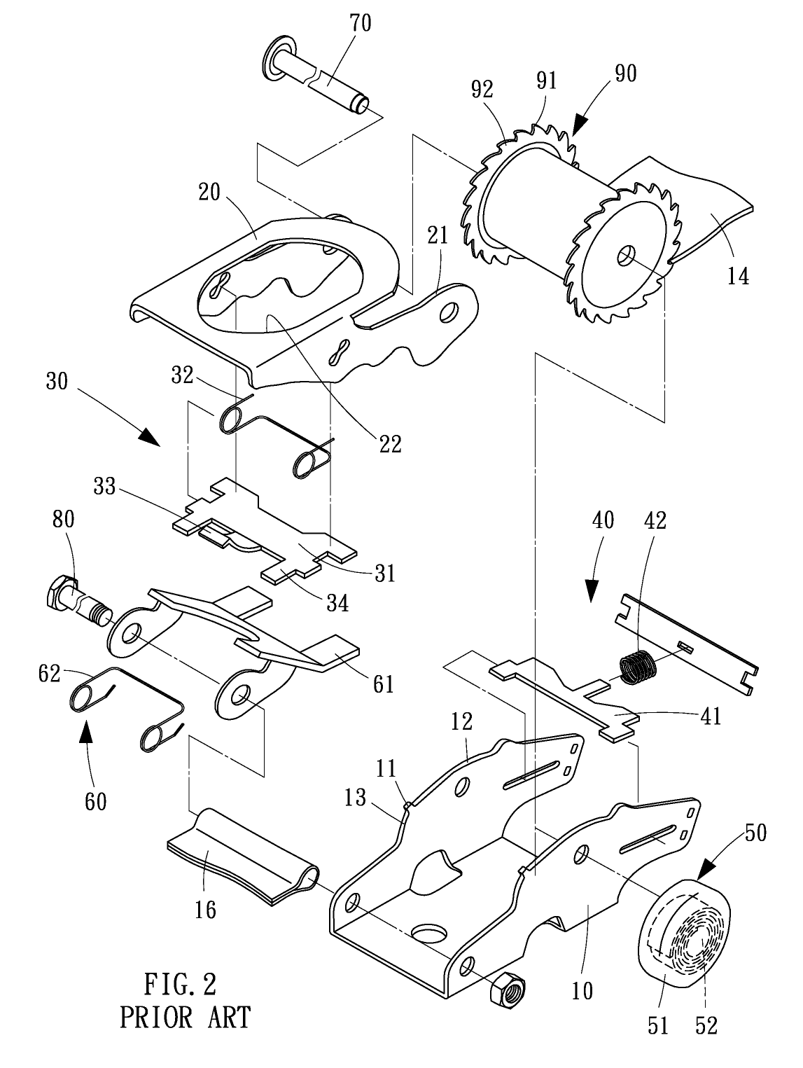

The cams 21 push the detent 41 so that the sum of the friction of the detent 31 against the ratchets 92 and the friction of the brake 63 against the ratchets 92 is larger than the recovering force of the coil spring 52 of the automatic reeling-in unit 50 (FIG. 2), thus keeping the ratcheted wheel 91s from rotation corresponding to the reeling in of the long strap 14. A force can be exerted on long strap 14 to overcome the friction and the recovering force to rotate the reel 90 to reel out the long strap 14. The long strap 14 is stopped because of the detent 31 and the brake 63 once the force is stopped.

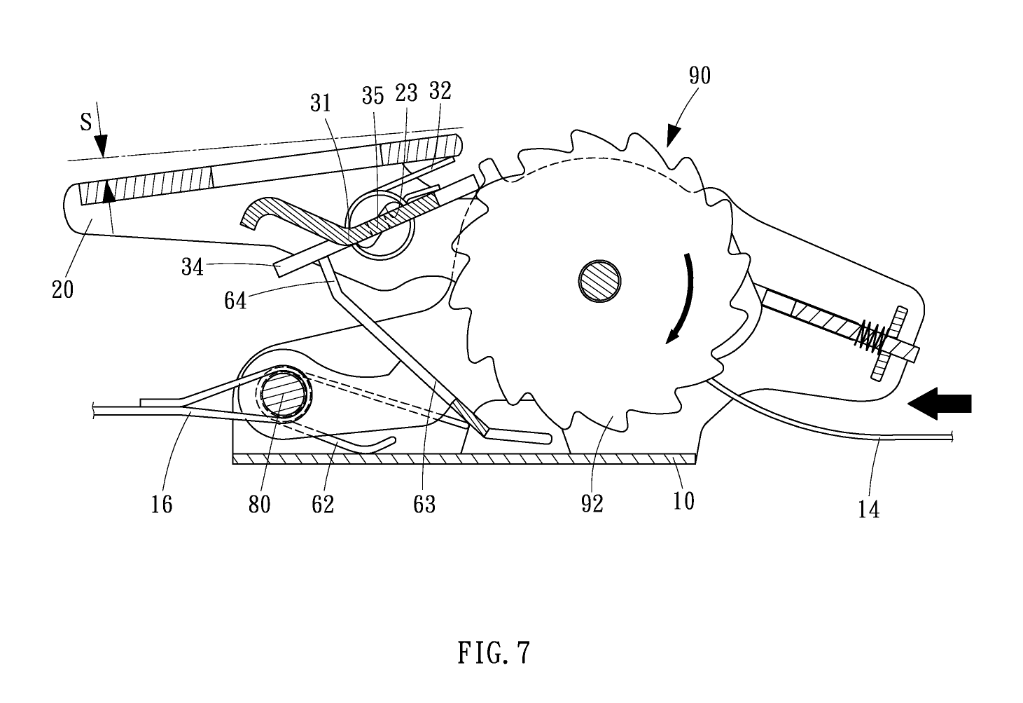

Referring to FIG. 7, the detent 31 includes two flat pivots 35 inserted in two slots 23 defined in the handle 20. By a triangle or dumbbell-shaped edge around each of the slots 23, the pivotal of the detent 31 is limited to a range. Once a force is exerted on the handle 20, the handle 20 is pivoted between a position shown in phantom lines and another position shown in a solid line within a range S. As the detent 31 is limited by the edges of the slots 23, the pushers 34 push the levers 64 to move the brake 63 away from the ratchets 92. Thus, the strap-tensioning apparatus 100 is in the automatic reeling-in mode. Now, the automatic reeling-in unit 50 causes the reel 90 to rotate to reel in the long strap 14. At the same time, biased by the torque spring 32, the detent 31 still exerts friction against the ratchets 92. The friction is smaller than the recovering force of the coil spring 52 so that the reeling in of the long strap 14 cannot be stopped but slowed. Therefore, the reeling in of the long strap 14 is automatic but slow, and so is the movement of the hook 15. That is, the risk of a fast moving hook 15 hurting anybody nearby is reduced.

As the handle 20 is released, the torque spring 62 biases the brake 63 so that the levers 64 of the brake 63 abut against the pushers 34 of the detent 31 to facilitate the returning of the handle 20 and allow the detent 31 and brake 63 to exert friction against the ratchets 92 as shown in FIG. 6.

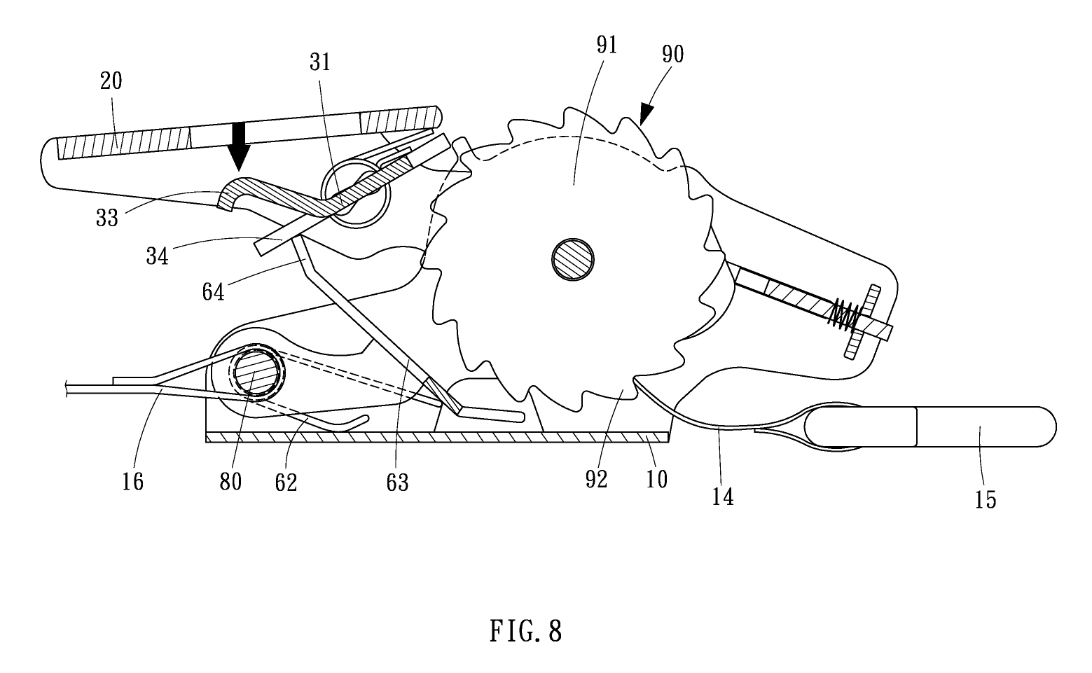

Referring to FIG. 8, the tab 33 is pushed, thus moving the detent 31 and the brake 63 out of the ratchets 92 and locating the ratcheted wheels 91 in a free state to allow the coil spring 52 to rotate the reel 90 to reel in the remaining section of long strap 14. Now, the recovering force of the coil spring 52 is small. Thus, the movement of the hook 15 is slow. The risk the risk of a fast moving hook 15 hurting anybody nearby is reduced.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A strap-tensioning apparatus including:
a frame including two walls each including first and second arched edges formed thereon;
a bolt supported on the frame;
a short strap tied to the bolt;
an axle supported on the frame;
a reel supported on the axle and formed with two ratcheted wheels each formed with a plurality of ratchets;
a long strap wound on the reel;
a coil spring for rotating the reel to reel in the long strap;
a first spring-biased detent supported on the frame for engagement with the ratchets;
a spring-biased brake supported on the frame for contact with the ratchets;
a handle supported on the axle and formed with two cams;
a second spring-biased detent pivotally attached to the handle, wherein as the second spring-biased detent is located on the second arched edges of the walls of the frame, the cams push the first spring-biased detent away from the ratchets and the second spring-biased detent can be pivoted between a first position in contact with the ratchets and a second position away from the ratchets, wherein the second spring-biased detent keeps the spring-biased brake away from the ratchets in the second position;
wherein the distance of the ratchets from the axle is longer than the distance of the second arched edges from the axle so that the second spring-biased detent frictionally contacts the ratchets on the second arched edges in the second position, thus slowing the reeling in of the long strap.

2. The strap-tensioning apparatus in accordance with claim 1, wherein the second spring-biased detent includes a tab operable to pivot the spring-biased detent between the first and second positions.

3. The strap-tensioning apparatus in accordance with claim 1, wherein the spring-biased brake includes two levers formed thereon, wherein the second spring-biased detent includes two pushers formed thereon for pushing the levers to move the spring-biased brake away from the ratchets.

4. The strap-tensioning apparatus in accordance with claim 3, wherein the levers are located at an angle of 1° to 180° from the brake.
